(19) United States
(12) Patent Application Publication
(10) Pub. No.: US 2024/0313980 A1
(43) Pub. Date: Sep. 19, 2024

(54) INFORMATION PROCESSING APPARATUS, METHOD FOR CONTROLLING THE SAME, AND STORAGE MEDIUM

(71) Applicant: CANON KABUSHIKI KAISHA, Tokyo (JP)

(72) Inventor: YUKI MINETOMO, Kanagawa (JP)

(21) Appl. No.: 18/606,379

(22) Filed: Mar. 15, 2024

(30) Foreign Application Priority Data
Mar. 17, 2023 (JP) 2023-043431

(51) Int. Cl. H04L 9/32

(52) U.S. Cl. CPC H04L 9/3247

(57) ABSTRACT

Some embodiments of an information processing apparatus comprise one or more memories and one or more processors. The one or more processors and the one or more memories are configured to determine, for partial data contained in electronic data to be a target of digital signature processing, a timing for calculating a code to be used in verification of authenticity of the partial data; and perform, pre-calculation of the code determined to be pre-calculable at a timing before a start of the digital signature processing, at the timing.

### BACKGROUND

### Field of the Disclosure

The present disclosure relates to an information processing apparatus, a method for controlling the information processing apparatus, and a storage medium.

### Description of the Related Art

Tampering with digital contents, such as images and videos, has become a social issue that troubles individuals and companies with the tampered digital contents distributed intentionally on the Internet and disinformation on fake images generated from the digital contents. Examples of countermeasures against the issue include ensuring authenticity (a state of being not altered) of digital contents, for which a digital signature as a known technique can be applied. The digital signature is a technique that uses an encryption technology to apply a digital signature to a digital content and enables authenticity of the content to be checked through verification of the digital signature. Companies and news media handling digital contents have been highly concerned with mechanisms for ensuring authenticity, and the Coalition for Content Provenance and Authenticity (C2PA) has been established by major companies and news media. The C2PA works for standardization of a mechanism for ensuring authenticity and provenance of digital contents. Incorporating data for ensuring authenticity specified in the C2PA standard into a digital content as meta data establishes the verifiability of authenticity and provenance of the digital content. Hereinafter, the data for ensuring the authenticity specified by the C2PA standard is also referred to as C2PA data.

Hash value calculation and digital signature processing are applied to generation and verification of the C2PA data, and various methods have been proposed for generation of data having undergone such processing.

Japanese Patent Application Laid-Open No. 2007-506187 discusses a technique for calculating hash values, targeting a plurality of pieces of data, and generating a digital signature based on these hash values. This technique divides program data on a page basis and calculates a hash value for each page. Hash value recalculation is further performed based on all the hash values, and digital signature processing is performed on the recalculated hash value, so that authenticity of the program data is able to be verified.

Japanese Patent Application Laid-Open No. 2011-250335 discloses a technique for pre-calculating calculable data in calculation of a digital signature, which increases the processing speed of the digital signature.

Meanwhile, there may be a concern that, in a case where image data is applicable as a target of ensuring the authenticity based on the C2PA data, digital signature processing is performed each time an imaging apparatus performs image capturing. Under such a situation, execution of the digital signature processing prolongs the processing time until completion of the image data generation based on a result of imaging. The influence of such an increase in the processing time for each image may become apparent as a phenomenon where, for example, a continuous shooting performance of the imaging apparatus is degraded, possibly adversely affecting the usability. Particularly with devices having limited calculation resources, such as imaging apparatuses called digital cameras, the processable data volume is limited, and thus a concern may arise that the processing time further increases. In the processing of the C2PA data, hash value calculation processing may be performed a plurality of times, which makes a tendency of the above-described influence associated with an increase in the processing time to be more apparent.

### SUMMARY

In consideration of the above-described issue, some embodiments of the present disclosure are directed to implementing digital signature processing on electronic data in a more desirable form.

According to an aspect of the present disclosure, an information processing apparatus includes one or more memories and one or more processors. The one or more processors and the one or more memories are configured to determine, for partial data contained in electronic data to be a target of digital signature processing, a timing for calculating a code to be used in verification of authenticity of the partial data, and perform pre-calculation of the code determined to be pre-calculable at a timing before a start of the digital signature processing, at the timing.

Further features of the present disclosure will become apparent from the following description of exemplary embodiments with reference to the attached drawings.

### BRIEF DESCRIPTION OF THE DRAWINGS

FIGS. 1A and 1B are diagrams illustrating examples of Coalition for Content Provenance and Authenticity (C2PA) data configurations.

FIGS. 2A and 2B are diagrams illustrating examples of C2PA assertions.

FIG. 3 is a diagram illustrating an example of a C2PA claim.

FIGS. 4A and 4B are flowcharts illustrating examples of processing for C2PA data generation.

FIG. 5 is a diagram illustrating an example of a hardware configuration of an imaging apparatus.

FIG. 6 is a functional block diagram illustrating an example of a functional configuration of the imaging apparatus.

FIG. 7 is a diagram illustrating an example of an assertion list.

FIG. 8 is a diagram illustrating an example of an assertion parameter list.

FIG. 9 is a flowchart illustrating an example of processing of the imaging apparatus.

FIG. 10 is a flowchart illustrating an example of processing of the imaging apparatus.

FIG. 11 is a functional block diagram illustrating an example of a functional configuration of the imaging apparatus.

FIG. 12 is a diagram illustrating an example of an assertion parameter pre-calculation list.

FIG. 13 is a diagram illustrating an example of an imaging-mode-based pre-calculation flag list.

FIGS. 14A and 14B are diagrams illustrating examples of results of updating the lists.

FIG. 15 is a flowchart illustrating an example of processing of the imaging apparatus.

### DESCRIPTION OF THE EMBODIMENTS

Hereinafter, exemplary embodiments of the present disclosure will be described in detail with reference to the accompanying drawings.

In the specification and the drawings, the same reference numerals are given to constituent elements having substantially the same functional configuration, and the redundant description will be omitted.

### <C2PA Data>

Coalition for Content Provenance and Authenticity (C2PA) data that can be a subject of application of the technique according to exemplary embodiments of the present disclosure will be described below to facilitate understanding of the feature of the technique.

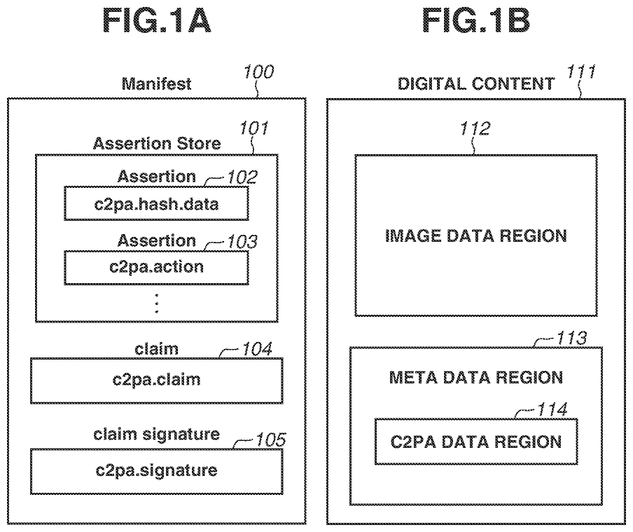

For example, FIG. 1A illustrates an example of a configuration of C2PA data. The C2PA data contains a manifest 100. FIG. 1B illustrates an example of a digital content 111 containing the C2PA data. The digital content 111 has an image data region 112 and a meta data region 113. The meta data region 113 has a C2PA data region 114. The C2PA data containing the manifest 100 is stored in the C2PA data region 114.

The manifest 100 contains an Assertion Store 101, a claim 104, and a claim signature 105.

The Assertion Store 101 stores assertions, such as assertions 102 and 103, containing information about authenticity of images and meta data. The assertions are data for implementation of the mechanism by which a condition to be satisfied in execution of a certain code is described and the condition is checked when the code is executed.

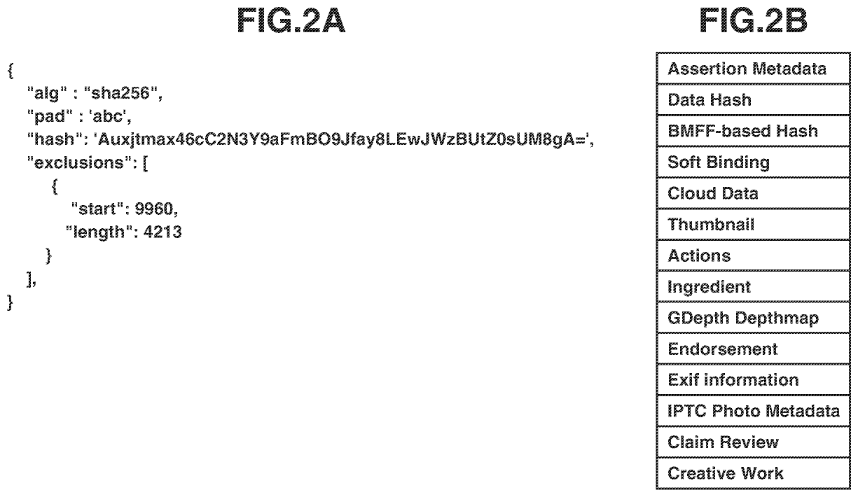

Examples of the assertions include a data hash assertion illustrated in FIG. 2A. The data hash assertion stores a hash value calculated based on data including a still image, a moving image, or meta data. At least one data hash assertion is included in the C2PA data. Each data hash assertion contains various parameters, such as “alg”, “pad”, “hash”, and “exclusions”. The parameter “alg” indicates an algorithm to be used for the hash calculation. The parameter “pad” indicates a byte sequence to be used for padding. The parameter “hash” indicates a hash value of the digital content. The parameter “exclusions” indicates information about a range of the hash value calculation. In the C2PA released version 1.0, assertions as illustrated in FIG. 2B are specified as standard assertions as well as data hash assertion.

The claim 104 stores storage locations of the assertions, their hash values, and other information, including the claim generator and a storage location of a digital signature of the claim.

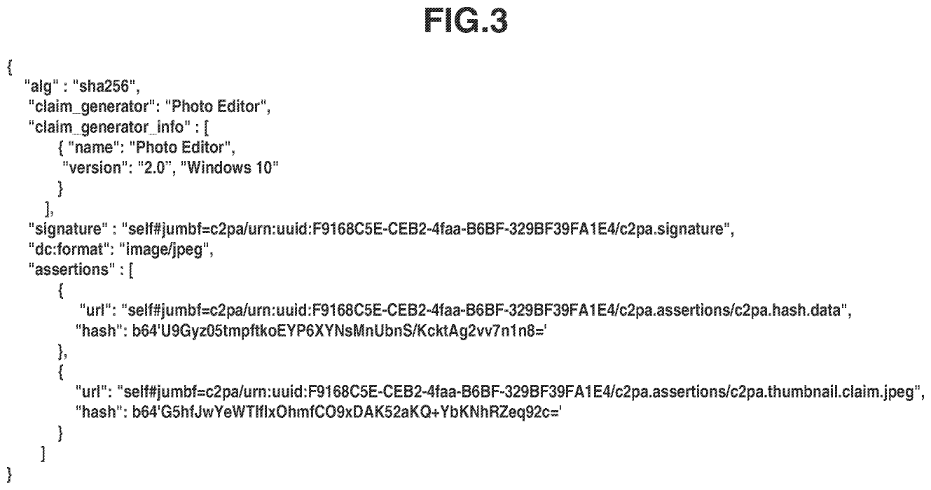

FIG. 3 illustrates an example of a claim. The claim contains the parameters “alg”, “claim_generator”, “claim_generator_info”, “signature”, “dc:format”, and “assertions”. The parameter “alg” indicates an algorithm used for the hash value calculation for assertions. The parameter “claim_generator” indicates an operating entity that generates a claim. The parameter “claim_generator_info” indicates supplementary information for “claim_generator”. The parameter “signature” indicates location information for a digital signature of the claim. The parameter “dc:format” indicates attribute information for the digital content. The parameter “assertions” indicates location information for the assertions and their hash values.

The claim signature 105 stores the digital signature value of the claim 104.

The above-described configuration is an example of the C2PA data, which may include other pieces of data specified by the C2PA standard.

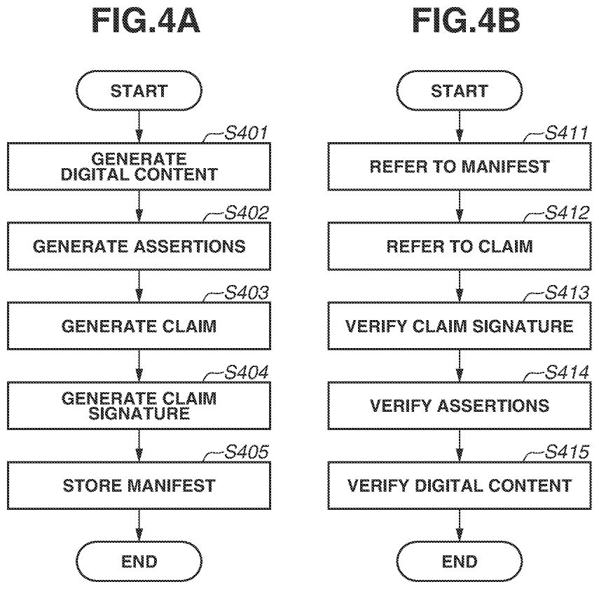

An example of processing for the C2PA data generation will be described below with reference to FIG. 4A.

In step S401, the information processing apparatus as the operating entity of the C2PA data generation starts C2PA data generation processing in response to generation of digital content, such as image capturing.

In step S402, the information processing apparatus generates the assertions 102 and 103 for images and meta data and calculates hash values for these assertions. The generated assertions are registered in the Assertion Store 101.

In step S403, the information processing apparatus generates the claim 104 based on storage locations of the generated assertions and their hash values.

In step S404, the information processing apparatus performs digital signature processing on the claim 104 to generate the claim signature 105.

In step S405, the information processing apparatus generates the manifest 100 storing the Assertion Store 101, the claim 104, and the claim signature 105, and stores the manifest 100 in the meta data region 113 for images.

The C2PA data for ensuring the authenticity is added to the digital content 111 in this way.

An example of processing for verification of the C2PA data will be described below with reference to FIG. 4B.

In step S411, the information processing apparatus as the operating entity of C2PA data verification refers to the manifest 100 of the digital content 111 storing the C2PA data.

In step S412, the information processing apparatus refers to the claim 104 stored in the manifest 100.

In step S413, the information processing apparatus verifies the claim 104 by using the claim signature 105.

After the verification of the claim 104, in step S414, the information processing apparatus verifies the assertions registered in the Assertion Store 101, by using the hash values of the assertions stored in the claim 104.

After the verification of the assertions, in step S415, the information processing apparatus verifies the digital content, such as an image, by using the data in the assertions.

The above-described series of processing is performed, whereby the information processing apparatus can verify authenticity of the target digital content.

The above-described processing for the C2PA data generation and processing for the C2PA data verification are illustrative, and optional generation and verification processing may be performed as long as the generation and processing are compliant with the rules described in the C2PA standard.

In consideration of the above-described operations, the present disclosure will be described below centering on an example of a technique for increasing the speed of processing for the C2PA data generation by pre-calculating the hash values of the assertions at a calculable timing in the C2PA data generation. The present disclosure will be described below centering on examples of a configuration and processing focusing on a case where an imaging apparatus, such as a digital camera, is applied as an example of an information processing apparatus. However, the relevant configuration and processing are not necessarily intended to limit the applications of the technique according to the present disclosure. More specifically, the technique according to the present disclosure is also applicable to information processing apparatuses other than imaging apparatuses.

### (Hardware Configuration)

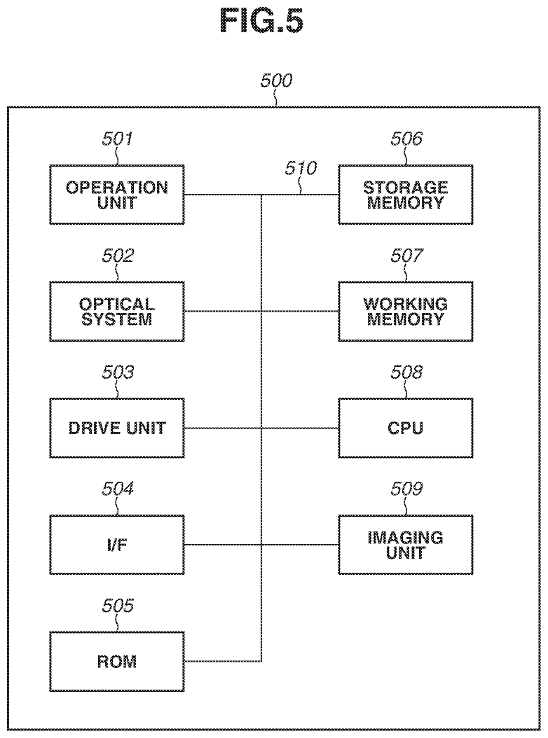

An example of a hardware configuration of the imaging apparatus according to a first exemplary embodiment of the present disclosure will be described below with reference to FIG. 5.

An imaging apparatus 500 includes an operation unit 501, an optical system 502, a drive unit 503, an interface (I/F) 504, and an imaging unit 509. The imaging apparatus 500 includes a central processing unit (CPU) 508, a read only memory (ROM) 505, a storage memory 506, and a working memory 507. The above-described components of the imaging apparatus 500 are connected via a bus 510 to transmit and receive information with each other.

The operation unit 501 provides the imaging apparatus with operation functions, and receives instructions from the user, including an instruction for imaging of the imaging apparatus, an instruction for changing settings at image capturing, and an instruction for changing other settings of the imaging apparatus.

The optical system 502 includes an optical sensor, such as a charge coupled device (CCD) and a complementary metal oxide semiconductor (CMOS). The optical system 502 may include optical members, such as a lens for guiding a subject image to the optical sensor. Upon reception of an imaging instruction via the operation unit 501, the optical system 502 captures an image of the subject and performs electrical signal processing and digital signal processing.

The drive unit 503 performs various mechanical operations for implementing image capturing of subjects, such as positional adjustments of lenses and other optical members included in the optical system 502.

The I/F 504 interfacing with a memory card, portable terminal, communication apparatus, and other external apparatuses is used, for example, to transmit image data to these external apparatuses.

The ROM 505, a read only memory, stores operation programs of the imaging apparatus 500.

The storage memory 506, a storage area for storing various data items and programs, stores processed image data, for example.

The working memory 507 is a storage area for temporarily storing various data. The use of the working memory 507 enables image data to be temporarily stored in the working memory 507, and the image data is subjected to compression and various calculation processing on the working memory 507.

The CPU 508 performs various operation controls of the imaging apparatus 500 and performs various computations. For example, in response to issuance of an imaging instruction via the operation unit 501, the CPU 508 may perform various computation processing, such as image data compression processing, according to a program stored in the ROM 505.

The imaging unit 509 generates image data and meta data based on a result of the subject imaging processing by the optical system 502 and results of computations by the CPU 508. The imaging unit 509 may generate the C2PA data while targeting the generated image data.

The configuration illustrated in FIG. 5 is to be considered as illustrative. The hardware configuration of the imaging apparatus 500 is not limited thereto as long as a functional configuration and processing (described below) can be implemented. As a specific example, components other than the above-described series of components may be added according to the functions implemented by the imaging apparatus 500.

### (Functional Configuration)

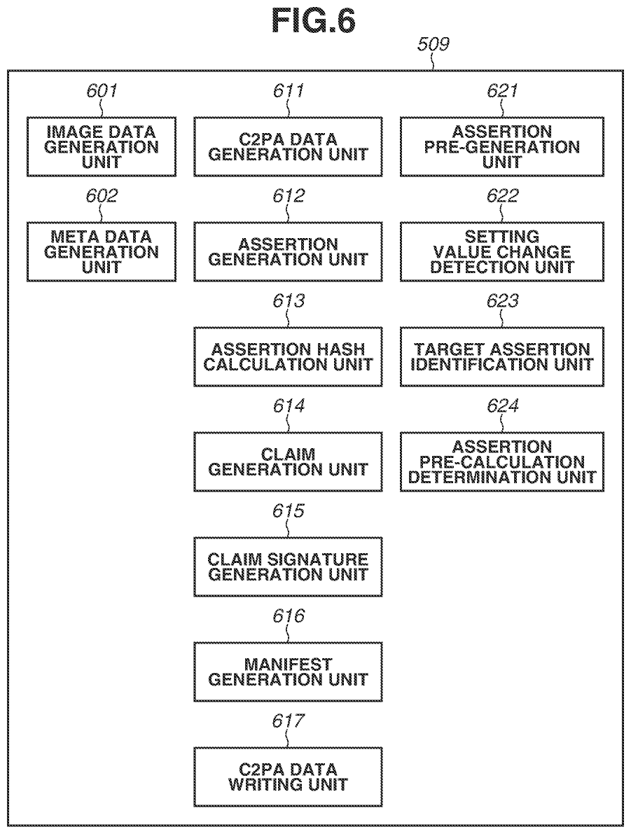

An example of a functional configuration of the imaging apparatus 500 according to the present exemplary embodiment will be described below with reference to FIG. 6, particularly focusing on the functional configuration implemented by software that is executed by the imaging unit 509. The functional configuration of the imaging unit 509 includes an image data generation unit 601 and a meta data generation unit 602. The functional configuration of the imaging unit 509 includes a C2PA data generation unit 611, an assertion generation unit 612, an assertion hash calculation unit 613, a claim generation unit 614, a claim signature generation unit 615, a manifest generation unit 616, and a C2PA data writing unit 617. The imaging unit 509 further includes an assertion pre-generation unit 621, a setting value change detection unit 622, a target assertion identification unit 623, and an assertion pre-calculation determination unit 624.

The image data generation unit 601 generates image data according to an instruction of the imaging unit 509. Examples of formats of generated image data include Joint Photographic Experts Group (JPEG) and Portable Network Graphics (PNG). The above-described formats are to be considered as illustrative, and image data formats other than JPEG and PNG are also applicable.

The meta data generation unit 602 generates meta data that accompanies image data generated by the image data generation unit 601. Examples of meta data formats include Exchangeable Image File Format (EXIF) and International Press Telecommunications Council (IPTC). The above-described examples are to be considered as illustrative, and other meta data formats other than EXIF and IPTC are also applicable as long as image data and user information can be stored in a predetermined format. Examples of information stored as meta data include imaging conditions (e.g., the shutter speed, F number, and International Organization for Standardization (ISO) sensitivity), the image file format and size, and user information. The meta data generated by the meta data generation unit 602 is written to the meta data region 113 for the image data generated by the image data generation unit 601.

After image data and meta data are generated by the image data generation unit 601 and the meta data generation unit 602, respectively, the C2PA data generation unit 611 starts generating the C2PA data.

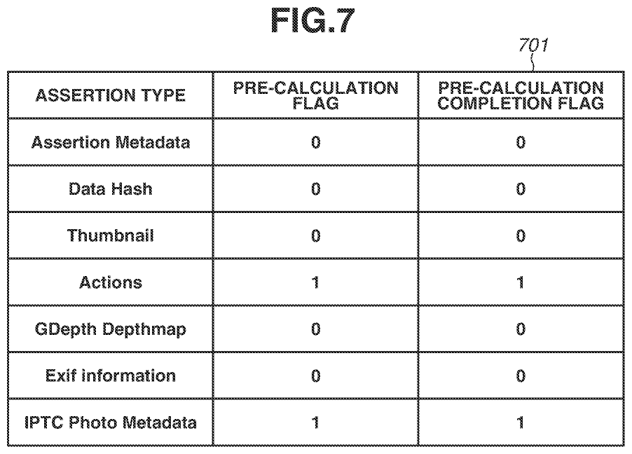

In response to receipt of an instruction from the C2PA data generation unit 611, the assertion generation unit 612 starts assertion generation processing and registers the generated assertions in the Assertion Store 101. The assertion generation unit 612 generates assertions as illustrated in FIG. 2B based on the image data and meta data. The assertions to be generated by the assertion generation unit 612 are determined based on an assertion list 701 illustrated in FIG. 7.

The assertion list 701 lists assertions that are generated by the assertion generation unit 612. Each assertion has settings of a pre-calculation flag and a pre-calculation completion flag. The pre-calculation flag indicates whether the relevant assertion can be pre-calculated before a start of the C2PA data generation processing (in other words, before the start of the digital signature processing). A specific example will be described below. The pre-calculation flag=0 indicates that the pre-calculation is difficult and that the relevant assertion needs to be generated after the start of the C2PA data generation processing. The pre-calculation flag=1 indicates that assertion generation and hash value calculation can be performed in advance.

The assertion generation unit 612 refers to the pre-calculation flag and the pre-calculation completion flag to perform the assertion generation processing. As a specific example, the assertion generation unit 612 generates assertions having the pre-calculation flag=0 and calculates their hash values after the start of the C2PA data generation. The pre-calculation flag=1 and the pre-calculation completion flag=0 indicate that the relevant assertion can be pre-calculated but has not yet been calculated. In this case, the assertion generation unit 612 generates such assertions and calculates their hash values. The pre-calculation flag=1 and the pre-calculation completion flag=1 indicate that the assertion pre-calculation has been completed by the assertion pre-generation unit 621 (described below). In this case, the assertion generation unit 612 reads such assertions and their hash values stored in the storage memory 506.

The pre-calculation completion flag is reset to 0 when power of the imaging apparatus is turned OFF. Although the assertions listed in the assertion list 701 have been described above as examples of assertions generated by the imaging apparatus, the assertions generated by the imaging apparatus may include other assertions specified by the C2PA standard and optional assertions.

The assertion generation unit 612 corresponds to an example of a second calculation unit.

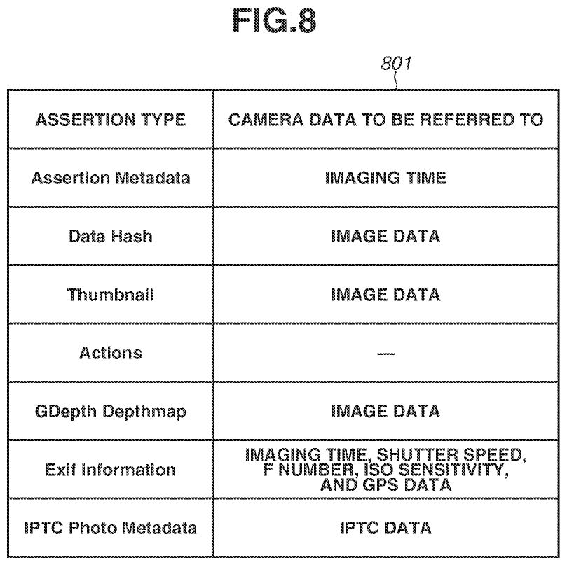

In generation of an assertion, not only character string information specified by the C2PA standard but also information about setting values specific to a camera and data generated in the camera are used. In a case where the above-described data specific to the camera is referred to, an assertion parameter list 801 illustrated in FIG. 8 is used.

The assertion parameter list 801 describes setting values and data in the imaging apparatus each of which is requested by the corresponding assertion. For example, since the hash value of image data is calculated when a data hash assertion is generated, image data is registered as data to be requested. As another example, in the generation of an action assertion representing processing in the C2PA data generation, only information indicating that the C2PA data has been generated is stored, and none of the setting values in the imaging apparatus is to be requested and thus not described.

The assertion generation unit 612 generates assertions based on the data referred to by the assertion parameter list 801 in addition to character string data specified by the C2PA standard. Generated and read assertions are registered in the Assertion Store 101. Although the data listed in the assertion parameter list 801 have been described above as examples of data to be requested in generation of assertions, the data to be requested in generation of assertions may include other data.

In response to instructions from the assertion generation unit 612 and the assertion pre-generation unit 621, the assertion hash calculation unit 613 calculates a hash value of the target assertion. For example, the CPU 508 or a dedicated hardware component for encryption processing may be used for the hash value calculation.

After generation of a series of assertions described in the assertion list 701 and calculation of their hash values by the assertion generation unit 612, the claim generation unit 614 starts claim generation processing. The claim generation unit 614 stores, in the claim 104, uniform resource identifier (URI) information indicating positions in the Assertion Store 101 where assertions and their hash values are stored. The claim 104 includes information indicating the operating entity that generated the claim 104, information representing the position of the claim signature 105, and the image data format, which are information specified by the C2PA standard.

After completion of the claim generation processing by the claim generation unit 614, the claim signature generation unit 615 generates the claim signature 105 as a digital signature for the claim 104. For example, a digital signature algorithm specified by the C2PA standard is used to generate the claim signature 105. The C2PA released version 1.0 specifies the use of algorithms, such as RSA Probabilistic Signature Scheme (RSASSA-PSS), Elliptic Curve Digital Signature Algorithm (ECDSA), and Edwards-curve Digital Signature Algorithm (EdDSA).

For example, the CPU 508 or a dedicated hardware component for encryption processing may be used for the digital signature processing.

The manifest generation unit 616 generates the manifest 100 for storing the Assertion Store 101, the claim 104, and the claim signature data.

The C2PA data writing unit 617 forms data, specified by the C2PA standard, including the manifest data generated by the manifest generation unit 616 as the C2PA data, and writes the data in the meta data region 113 for image data. The position where the C2PA data is written and the method for writing the C2PA data conform to the format specified by the C2PA standard.

The assertion pre-generation unit 621 generates assertions and calculates their hash values based on a predetermined trigger at a timing other than the timing when the C2PA data generation unit 611 performs the C2PA data generation processing. As a specific example, the assertion pre-generation unit 621 may generate assertions and calculate their hash values in response to activation of the imaging apparatus (e.g., power ON) or in response to receipt of an instruction from the assertion pre-calculation determination unit 624 which will be described below.

The assertion pre-generation unit 621 refers to the pre-calculation flags in the assertion list 701 to identify an assertion to be a target of the pre-calculation. For example, the assertion having the pre-calculation flag=1 in the assertion list 701 indicates that the assertion and the hash value can be calculated at a timing other than the timing when the C2PA data generation processing is performed. Thus, the assertion pre-generation unit 621 generates assertions having the pre-calculation flag=1 and calculates the hash value. For example, because the assertion IPTC Photo Metadata is generated based on IPTC data input by the user, the relevant parameter to be applied at image capturing remains unchanged. Thus, assertions targeting such meta data can be pre-calculated. As for imaging apparatus specific data to be used in generation of an assertion, the target assertion identification unit 623 refers to the assertion parameter list 801. The generated assertion and the hash value are stored in the storage memory 506.

After the generation of assertions, the assertion pre-generation unit 621 updates the pre-calculation completion flags corresponding to the generated assertion in the assertion list 701 to 1.

The assertion generation unit 612 is used to generate assertions, and the assertion hash calculation unit 613 is used to calculate their hash values.

Although, in the above-described example, the assertion pre-generation unit 621 refers to the assertion list 701 to determine assertions to be pre-generated, the assertion pre-generation unit 621 may subject assertions specified by the assertion pre-calculation determination unit 624 to the pre-calculation.

According to the present exemplary embodiment, a hash value corresponds to an example of a code that is used in verification of authenticity of target data (such as an assertion). An assertion corresponds to an example of partial data that is contained in electronic data to be a target of the digital signature processing and is a target of the hash value calculation. The assertion pre-generation unit 621 corresponds to an example of a first calculation unit.

The setting value change detection unit 622 detects a change in a setting value of the imaging apparatus. As a specific example, imaging condition settings (e.g., the shutter speed, F number, and ISO sensitivity, and the IPTC data) are the values that can be changed by a user operation. In a case where a setting value has been changed by a user operation, the setting value change detection unit 622 may detect the change in the setting value. In a case where a setting value or data other than the above-described ones has been changed by a user operation, the setting value change detection unit 622 may detect the change. The setting value change detection unit 622 transmits the type of the parameter, a setting value change of which has been detected, to the target assertion identification unit 623.

An assertion to be generated is identified such that the target assertion identification unit 623 identifies whether a parameter, information on which has been acquired from the setting value change detection unit 622, is a parameter to be requested in generation of an assertion. In the identification of an assertion, the target assertion identification unit 623 uses the assertion parameter list 801. For example, in a case where the setting value change detection unit 622 designates the shutter speed as a parameter in which a change has been detected, the target assertion identification unit 623 refers to the assertion parameter list 801 to identify that Exif information is a related assertion. The target assertion identification unit 623 transmits the result of identifying an assertion to be generated to the assertion pre-calculation determination unit 624.

The assertion pre-calculation determination unit 624 determines whether the assertion transmitted from the target assertion identification unit 623 can be pre-calculated. The assertion pre-calculation determination unit 624 refers to the relevant pre-calculation flag in the assertion list 701 to determine whether the target assertion can be pre-calculated. In a case where the assertion pre-calculation determination unit 624 determines that the assertion can be pre-calculated, the assertion pre-calculation determination unit 624 transmits the relevant assertion to the assertion pre-generation unit 621 to instruct the assertion pre-generation unit 621 to start pre-calculation processing for the relevant assertion.

For example, in a case where the determination target assertion is IPTC Photo Metadata, the relevant pre-calculation flag in the assertion list 701 is 1. In this case, therefore, the assertion pre-calculation determination unit 624 determines that the target assertion can be pre-calculated and transmits the relevant assertion to the assertion pre-generation unit 621 as a pre-calculation target. As another example, in a case where the determination target assertion is Exif information, the relevant pre-calculation flag in the assertion list 701 is 0. In this case, the assertion pre-calculation determination unit 624 determines that the target assertion is not a target of the pre-calculation, and ends the processing.

As described above, the assertion pre-calculation determination unit 624 determines the timing for performing various calculations (e.g., the hash value calculation) on the assertion transmitted from the target assertion identification unit 623.

### (Processing)

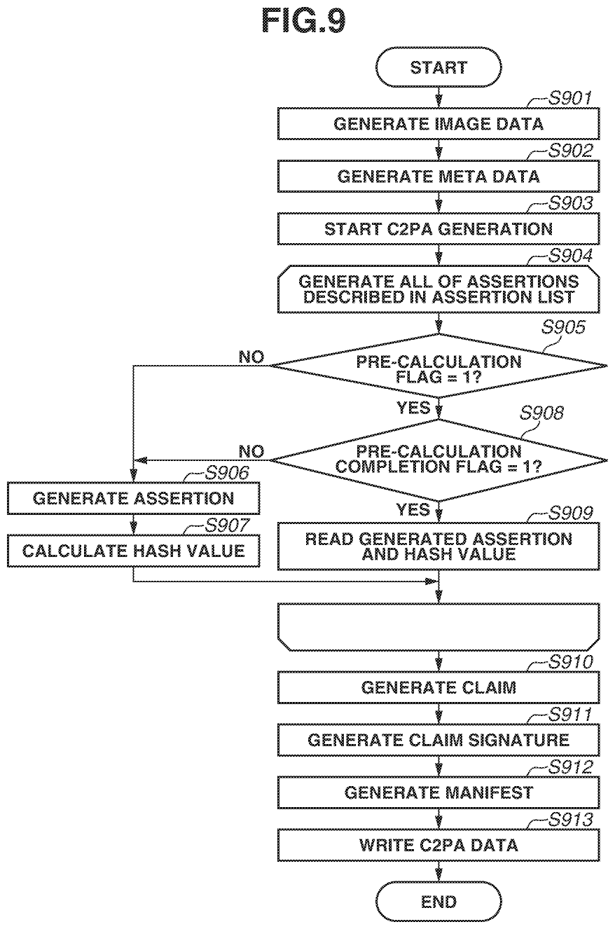

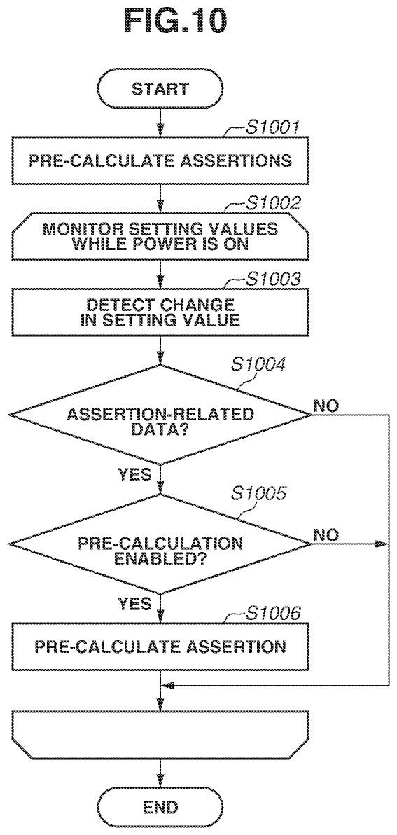

An example of processing of the imaging apparatus according to the present exemplary embodiment will be described below with reference to FIGS. 9 and 10, particularly focusing on processing for increasing the speed of the C2PA data generation processing through the assertion pre-calculation.

An example of the C2PA data generation processing when the imaging apparatus performs image capturing will be described below with reference to FIG. 9.

When the imaging apparatus performs image capturing based on an instruction from the user, in step S901, the image data generation unit 601 generates image data according to a result of the image capturing.

In step S902, the meta data generation unit 602 generates meta data, targeting the image data generated in step S901, and incorporates the meta data in the image data.

In step S903, the C2PA data generation unit 611 starts the C2PA data generation processing, targeting the image data generated in step S901 and the meta data generated in step S902.

In step S904, in response to an instruction from the C2PA data generation unit 611, the assertion generation unit 612 starts processing for generation of the assertions described in the assertion list 701.

In step S905, the assertion generation unit 612 refers to the pre-calculation flag in the assertion list 701 to determine whether the target assertion can be pre-calculated.

In a case where the assertion generation unit 612 determines that the target assertion can be pre-calculated (YES in step S905), the processing proceeds to step S908.

In a case where the assertion generation unit 612 determines that the target assertion cannot be pre-calculated (NO in step S905), the processing proceeds to step S906.

In step S908, the assertion generation unit 612 refers to the pre-calculation completion flag in the assertion list 701 to determine whether the target assertion pre-calculation has been completed.

In a case where the assertion generation unit 612 determines that the target assertion pre-calculation has been completed (YES in step S908), the processing proceeds to step S909.

In a case where the assertion generation unit 612 determines that the target assertion pre-calculation has not been completed (NO in step S908), the processing proceeds to step S906.

In step S906, the assertion generation unit 612 generates the target assertion.

In step S907, the assertion hash calculation unit 613 calculates the hash value, targeting the assertion generated in step S906.

In step S909, the assertion generation unit 612 reads the generated assertion and its hash value stored in the storage memory 506.

In this way, the assertion generation unit 612 and the assertion hash calculation unit 613 repetitively perform the processing in steps S905 to S909 until generation of the series of assertions described in the assertion list 701 is completed. In a case where the assertion generation unit 612 completes generation of the series of assertions described in the assertion list 701, the processing proceeds to step S910.

In step S910, the claim generation unit 614 generates the claim 104 based on the result of the generation of the series of assertions in steps S904 to S909.

After completion of the claim generation, in step S911, the claim signature generation unit 615 generates the claim signature 105, targeting the claim generated in step S910.

In step S912, the manifest generation unit 616 generates the manifest 100 based on the result of the claim generation in step S910 and the result of the claim signature generation in step S911.

After completion of generation of the C2PA data as described above, in step S913, the C2PA data writing unit 617 writes the generated C2PA data to the meta data region 113 for image data (the image data generated in step S901).

An example of assertion pre-calculation processing will be described below with reference to FIG. 10.

When the power of the imaging apparatus is turned ON, step S1001, the assertion pre-generation unit 621 refers to the assertion list 701 and performs the assertion pre-calculation.

In step S1002, the setting value change detection unit 622 starts monitoring the setting values of the imaging apparatus. During the powering ON of the imaging apparatus, the setting value change detection unit 622 continues monitoring the setting values of the imaging apparatus.

In a case where the setting value change detection unit 622 has detected a change in a setting value, the setting value change detection unit 622 transmits a parameter of which change has been detected in step S1003 to the target assertion identification unit 623.

In step S1004, the target assertion identification unit 623 determines whether the parameter transmitted from the setting value change detection unit 622 in step S1003 is an assertion-related parameter.

In a case where the target assertion identification unit 623 determines that the target parameter is an assertion-related parameter (YES in step S1004), the processing proceeds to step S1005.

In a case where the target assertion identification unit 623 determines that the target parameter is not an assertion-related parameter (NO in step S1004), the target assertion identification unit 623 ends the processing on the relevant parameter. In this case, the processing skips steps S1005 and S1006 and returns to step S1003.

In step S1005, the assertion pre-calculation determination unit 624 determines whether the target assertion can be pre-calculated.

In a case where the assertion pre-calculation determination unit 624 determines that the target assertion can be pre-calculated (YES in step S1005), the processing proceeds to step S1006.

In a case where the assertion pre-calculation determination unit 624 determines that the target assertion cannot be pre-calculated (NO in step S1005), the assertion pre-calculation determination unit 624 ends the processing targeting the relevant assertion. In this case, the processing skips step S1006 and returns to step S1003.

In step S1006, the assertion pre-generation unit 621 generates the target assertion and its hash value and changes the pre-calculation completion flag for the generated assertion to 1.

As described above, during the powering ON of the imaging apparatus, the series of processing in steps S1003 to S1006 is repetitively performed.

As described above, the present exemplary embodiment generates at least a part of the assertions and calculates their hash values in advance in the C2PA data generation, thus increasing the speed of the C2PA data generation processing. The assertions not determined to be a target of the pre-calculation will be generated, and their hash value will be calculated, after the start of the C2PA data generation processing (in other words, the digital signature processing).

### First Modification Example

The above-described exemplary embodiments have been described centering on an example case where the assertion pre-calculation is performed at the timing when a setting value is changed by a user operation. A first modification example will be described below centering on an example case where the assertion pre-calculation is performed using a time lapse as a trigger.

More specifically, the above-described exemplary embodiment is for the case in which the assertion pre-calculation is performed mainly at a timing of a data update. In this case, since the assertion pre-calculation processing is to be performed each time the user changes a setting value, the power consumption may further increase depending on the frequency of setting value changes. In consideration of such a situation, the imaging apparatus according to the present modification example performs the assertion pre-calculation processing by using a time lapse as a trigger. As a specific example, the imaging apparatus may perform processing for regeneration of the series of assertions that can be pre-calculated, each time when a predetermined time period (e.g., one minute) has elapsed. The frequency of the assertion pre-calculation in response to a time lapse may be suitably changed depending on a use case. As a specific example, a time period to be used as a trigger for the assertion pre-calculation may be preset or changed according to an instruction from the user.

### Second Modification Example

The above-described exemplary embodiment has been described centering on an example case where the assertion pre-calculation is performed at a timing when the power of the imaging apparatus is turned ON. A second modification example will be described below centering on an example case where the assertion pre-calculation is performed at a timing when the imaging apparatus returns from a sleep state.

More specifically, in a case of the imaging apparatus with a sleep function, the imaging apparatus is able to turn some functions OFF with data retained (i.e., the apparatus enters the sleep state). In the sleep state, the assertions pre-calculated when power has been turned ON may be retained. However, there can be a case in which some settings are changed by an operation performed on a physical button or dial during the sleep state. In consideration of such a situation, the imaging apparatus according to the present modification performs the assertion pre-calculation when returning from the sleep state. Applying such control enables, even in a case in which, for example, some settings have been changed in the sleep state, the imaging apparatus to perform the assertion pre-calculation again at a timing when the imaging apparatus returns from the sleep state, whereby the imaging apparatus retains the assertions according to the latest condition.

### Third Modification Example

The above-described exemplary embodiment has been described centering on an example case where the assertion pre-calculation is performed at a timing when a setting value is changed by a user operation. A third modification example will be described below centering on an example case where the assertion pre-calculation is performed at a timing of a data update associated with data transmission from the outside.

More specifically, examples of data to be referred to by assertions include global positioning system (GPS) data. Location of positional information on a target by using GPS data is performed based on data transmitted from a satellite. Thus, the GPS data is updated at a timing of data reception from the satellite. In consideration of such a situation, the imaging apparatus according to the present modification example performs the assertion pre-calculation at a timing of a data update associated with data transmission from the outside. Applying such control enables, even in a case in which, for example, some settings have been changed along with data transmission from the outside, the imaging apparatus to perform the assertion pre-calculation in response to update of the relevant data, whereby the imaging apparatus retains the assertions according to the latest condition.

A second exemplary embodiment of the present disclosure will be described below. According to the present exemplary embodiment, components substantially similar to those in the first exemplary embodiment are assigned the same reference numerals as those in the first exemplary embodiment. The present exemplary embodiment will be described below focusing on differences from the first exemplary embodiment, and detailed descriptions of portions substantially similar to those in the first exemplary embodiment will be omitted.

According to the first exemplary embodiment, determination of the assertions to be targets of the pre-calculation and the parameters contained in the assertions are performed based on the assertion list 701 and the assertion parameter list 801, which are prestored. The present exemplary embodiment will be described below centering on an example case where an assertion to be a target of the pre-calculation and the parameter contained in the assertion are changed at when an imaging mode is changed.

Some imaging apparatuses, such as digital cameras, have a function of changing an imaging-related operation mode (imaging mode) when capturing an image of a subject. In such an imaging apparatus, determination of whether, for example, imaging-related parameters are to be changed based on a user input or through program control in the imaging apparatus is performed when the imaging mode is changed. In this case, a timing of application of the parameters may change according to the imaging mode. In consideration of such a situation, in the imaging apparatus according to the present exemplary embodiment, assertions to be targets of the pre-calculation and the parameters contained in the assertions are changed according to the imaging mode.

### (Functional Configuration)

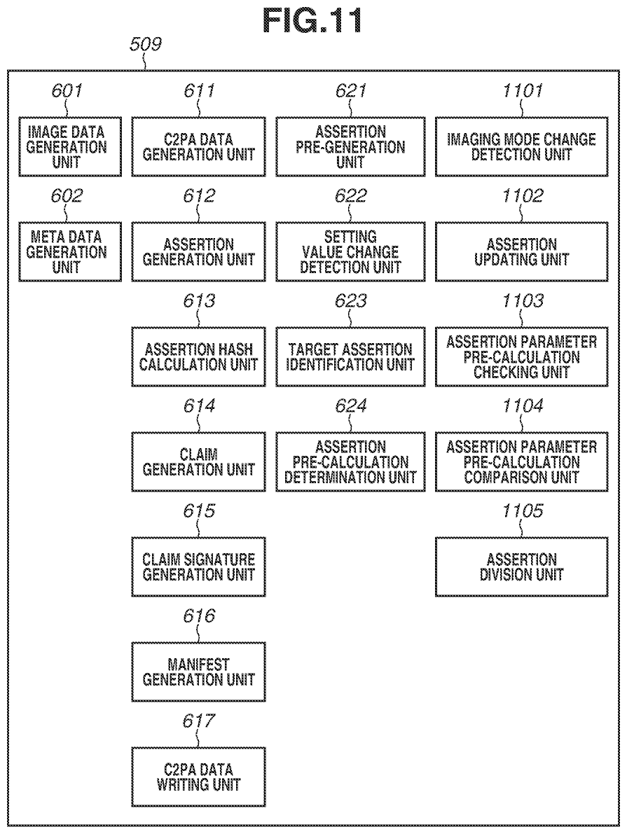

An example of a functional configuration of the imaging apparatus 500 according to the present exemplary embodiment will be described below with reference to FIG. 11, particularly focusing on a functional configuration implemented by software executed by the imaging unit 509. The imaging unit 509 according to the present exemplary embodiment includes an imaging mode change detection unit 1101, an assertion updating unit 1102, an assertion parameter pre-calculation checking unit 1103, an assertion parameter pre-calculation comparison unit 1104, and an assertion division unit 1105. The imaging unit 509 according to the present exemplary embodiment differs from the imaging unit 509 according to the first exemplary embodiment in that these components are included.

The imaging mode change detection unit 1101 detects a change in the imaging mode of the imaging apparatus 500. In response to detection of an imaging mode change, the imaging mode change detection unit 1101 transmits information about the imaging mode after the change to the assertion updating unit 1102.

In response to receipt of the imaging mode change, the assertion updating unit 1102 starts processing for updating of the assertion list 701 and the assertion parameter list 801 according to the imaging mode after the change. The assertion updating unit 1102 performs the update processing for each assertion described in the assertion list 701.

The assertion parameter pre-calculation checking unit 1103 refers to the assertion list 701 and the assertion parameter list 801 to check the current pre-calculation flag for each parameter.

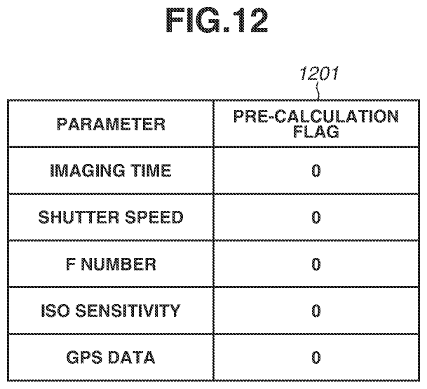

An example of an assertion parameter pre-calculation list 1201 will be described below with reference to FIG. 12. The assertion parameter pre-calculation list 1201 indicates the pre-calculation flag for each parameter to be referred to in Exif information in the automatic mode. Thus, by referring to the assertion list 701 and the assertion parameter list 801, the assertion parameter pre-calculation checking unit 1103 can check the pre-calculation flag for each parameter that is required for assertion generation.

As a specific example, the pre-calculation flag for Exif information is 0 in the assertion list 701. Consequently, the pre-calculation flags for the parameters for Exif information, which are imaging time, shutter speed, F number, ISO sensitivity, and GPS data, described in the assertion parameter list 801 are set to 0.

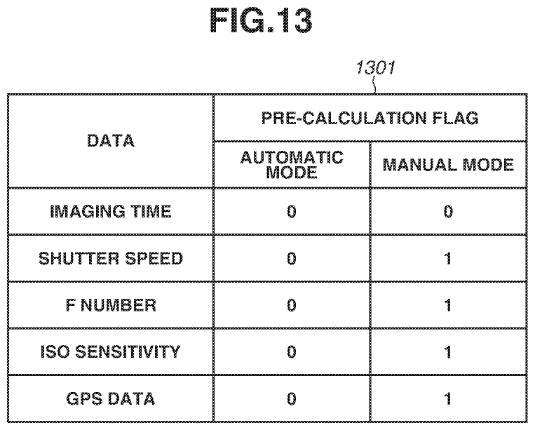

The assertion parameter pre-calculation comparison unit 1104 determines whether the current assertion parameter coincides with the pre-calculation flag for the assertion parameter for each imaging mode. As a specific example, in the above-described comparison, the assertion parameter pre-calculation comparison unit 1104 refers to the assertion parameter pre-calculation list 1201 in FIG. 12 and an imaging-mode-based pre-calculation flag list 1301 in FIG. 13. The imaging-mode-based pre-calculation flag list 1301 describes whether the pre-calculation of specific parameters in the imaging apparatus for each imaging mode can be performed.

For example, there are two different imaging modes: an automatic mode and a manual mode. In the automatic mode, imaging condition parameters, such as shutter speed, F number, ISO sensitivity, are controlled by the program of the imaging apparatus, whereby target parameters are applied at a timing of image capturing. In the manual mode, the above-described imaging condition parameters are changed by a user operation, whereby target parameters are applied at a timing when the user performs an input. Accordingly, in the imaging-mode-based pre-calculation flag list 1301, the pre-calculation flag for the parameters, such as shutter speed, F number, ISO sensitivity, are set to 1 indicating that these values can be pre-calculated in the manual mode. In the automatic mode, the pre-calculation flags for the above-described parameters are set to 0 indicating that these values are applied at a timing of image capturing. Meanwhile, as for the parameters, such as the imaging time, not to be targets of the pre-calculation even in a case where the imaging mode is changed, the pre-calculation flags remain 0.

While the automatic mode and the manual mode have been described above as the imaging mode, the imaging mode may include other imaging modes. Although imaging condition parameters have been described above as parameters that change according to the imaging mode, the image condition parameters may include other imaging-related parameters.

The assertion parameter pre-calculation comparison unit 1104 compares the series of the pre-calculation flags in the assertion parameter pre-calculation list 1201 and the relevant flags in the imaging-mode-based pre-calculation flag list 1301, targeting the information corresponding to the currently set imaging mode. In a case where the series of pre-calculation flags as targets of comparison in the above-described two lists do not match, the assertion parameter pre-calculation comparison unit 1104 instructs the assertion division unit 1105 (described below) to perform assertion parameter update processing.

As a specific example, in a case of Exif information in the manual mode, the pre-calculation flags for the shutter speed, F number, ISO sensitivity, and GPS data in the imaging-mode-based pre-calculation flag list 1301 do not coincide with the relevant flags in the assertion parameter pre-calculation list 1201. In this case, these parameters are determined as targets of the assertion parameter update processing.

The assertion division unit 1105 refers to the imaging-mode-based pre-calculation flag list 1301 to divide and register an assertion based on the relevant pre-calculation flag. As a specific example, the imaging-mode-based pre-calculation flag list 1301 for Exif information in FIG. 13 includes the pre-calculation flags having values 0 and 1. The assertion division unit 1105 divides the assertion based on the relevant pre-calculation flag. Thus, the assertion division unit 1105 generates an assertion “Exif information” having the pre-calculation flag=0, and an assertion “Exif information 2” having the pre-calculation flag=1. The assertion list 701 and the assertion parameter list 801 are updated with this assertion division.

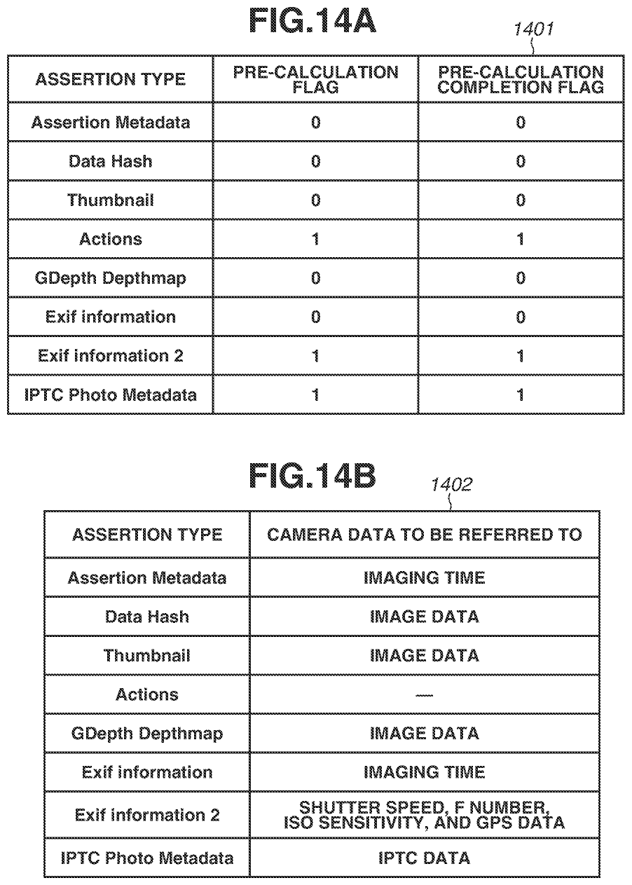

FIGS. 14A and 14B illustrate examples of an assertion list 1401 and an assertion parameter list 1402, which have been updated, respectively. As described above, the assertions “Exif information” and “Exif information 2” are registered in the assertion list 1401. Parameters are also assigned in the assertion parameter list 1402 based on their pre-calculation flags.

### (Processing)

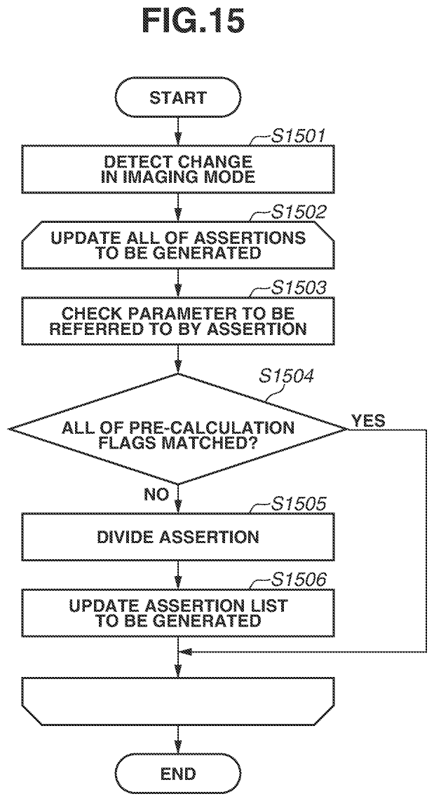

An example of processing of the imaging apparatus according to the present exemplary embodiment will be described below with reference to FIG. 15, particularly focusing on assertion update processing which is associated with the imaging mode change.

In step S1501, the imaging mode change detection unit 1101 detects a change in the imaging mode of the imaging apparatus.

In response to detection of the imaging mode change, in step S1502, the assertion updating unit 1102 starts a series of assertion update processing.

In step S1503, the assertion parameter pre-calculation checking unit 1103 checks whether each parameter to be referred to by the relevant assertion in the imaging mode before the change can be pre-calculated.

In step S1504, the assertion parameter pre-calculation comparison unit 1104 determines whether all the pre-calculation flags for the series of parameters are matched between the relevant assertions before and after the imaging mode change.

In a case where the assertion parameter pre-calculation comparison unit 1104 determines that all the pre-calculation flags for the series of parameters are matched between the relevant assertions before and after the imaging mode change (YES in step S1504), the assertion parameter pre-calculation comparison unit 1104 performs the processing in step S1503 and subsequent steps again, targeting the next assertion.

In a case where the assertion parameter pre-calculation comparison unit 1104 determines that at least a part of the pre-calculation flags for the parameters does not match between the relevant assertions before and after the imaging mode change (NO in step S1504), the processing proceeds to step S1505.

In step S1505, based on the pre-calculation flags for the series of the parameters to be referred to by the target assertion, the assertion division unit 1105 divides the relevant assertion.

In step S1506, the assertion division unit 1105 updates the assertion list to be generated, based on the result of the assertion division in step S1505.

The imaging unit 509 performs the processing in steps S1503 to S1506 for the series of the assertions to be generated. Then, after completion of the processing in steps S1503 to S1506 for the series of the assertions to be generated, the imaging unit 509 ends the series of the processing in FIG. 15.

Applying the above-described control implements processing for changing the assertions that can be pre-calculated, and the parameters contained in the assertions, according to the imaging mode.

### Other Exemplary Embodiments

Some embodiments of the present disclosure can also be achieved when computer-executable instructions (e.g., a program) for implementing at least one of the functions according to the above-described exemplary embodiments is supplied to a system or apparatus via a network or storage medium, and at least one processor in the computer of the system or apparatus reads and executes the computer-executable instructions. Some embodiments of the present disclosure can also be achieved by a circuit, such as an application specific integrated circuit (ASIC) for implementing at least one function.

The above-described exemplary embodiments can be modified in diverse ways without departing from the basic technical concept of the present disclosure.

For example, in the first and second exemplary embodiments, a plurality of assertions difficult to be pre-calculated before the start of the digital signature processing is generated. However, the assertions may be generated after their parameters that are difficult to be pre-calculated have been merged. As a specific example, assertions may be generated after parameters other than the parameters determined to be able to be pre-calculated have been merged to parameters of which hash values are calculated at a timing of image capturing (i.e., other parameters difficult to be pre-calculated).

As another example, in the hash value calculation, hardware components for encryption processing may be used and an overhead may occur during access to these hardware components. A mechanism for reducing the number of times of the hash value calculation may be applied to reduce such an overhead. As a specific example, the number of times of the pre-calculation can be reduced by including the parameters difficult to be pre-calculated in data hash assertion. Data hash assertion stores therein the hash value calculated for data including image data itself, and includes information for the range of the hash value calculation. For example, the flags for the manual mode in the imaging-mode-based pre-calculation flag list 1301 in FIG. 13 indicate that only the imaging time among the parameters included in Exif Information cannot be pre-calculated. Including the imaging time in data hash assertion enables the pre-calculation of all the parameters included in Exif Information. With the above-described control, an effect of reducing the number of times of the hash value calculation can be expected.

While, in the above-described exemplary embodiments, example embodiments according to the present disclosure have been described above mainly focusing on assertion calculation processing, targeting the C2PA data, the application target of some embodiments is not limited thereto. More specifically, some embodiments of the present disclosure can be applied under a situation where, when the digital signature is performed on target data, a plurality of pieces of partial data (e.g., assertions) is individually targeted for a predetermined calculation, such as the hash value calculation. As is clear from the above-described characteristics, some embodiments of the present disclosure are highly applicable to a use case in a situation that data, which can be pre-calculated, may be included in at least a part of the plurality of pieces of partial data contained in the processing target data.

Although the above-described exemplary embodiments have been described centering on an example case where a hash value is applied as a code to be used in verification of the authenticity of data, the code to be used for this purpose is not limited to a hash value as long as the authenticity can be verified. Particularly in a situation where a code with which the calculation time tends to prolong is applied, application of the techniques according to the present disclosure enable improvement in the speed of the digital signature processing that is associated with the pre-calculation of the code.

### OTHER EMBODIMENTS

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has described exemplary embodiments, it is to be understood that some embodiments of the disclosure are not limited to the disclosed exemplary embodiments. The scope of the following claims is to be accorded the broadest interpretation so as to encompass all such modifications and equivalent structures and functions.

This application claims priority to Japanese Patent Application No. 2023-043431, which was filed on Mar. 17, 2023 and which is hereby incorporated by reference herein in its entirety.

What is claimed is:

1. An information processing apparatus comprising:
one or more memories; and
one or more processors, wherein the one or more processors and the one or more memories are configured to:
determine, for partial data contained in electronic data to be a target of digital signature processing, a timing for calculating a code to be used in verification of authenticity of the partial data; and
perform pre-calculation of the code determined to be pre-calculable at a timing before a start of the digital signature processing, at the timing.

2. The information processing apparatus according to claim 1, wherein the one or more processors and the one or more memories are further configured to, in a case where at least part of information contained in the partial data has been changed in response to input from a user, determine a timing for calculating the code while targeting the partial data.

3. The information processing apparatus according to claim 1, wherein the one or more processors and the one or more memories are further configured to, in a case where at least part of information contained in the partial data has been changed along with data transmission from an outside, determine a timing for calculating the code while targeting the partial data.

4. The information processing apparatus according to claim 1, wherein the one or more processors and the one or more memories are further configured to, in a case where power of the information processing apparatus is turned ON, determine a timing for calculating the code while targeting the partial data contained in the electronic data.

5. The information processing apparatus according to claim 1, wherein the one or more processors and the one or more memories are further configured to, in a case where the information processing apparatus has returned from a sleep state, determine a timing for calculating the code while targeting the partial data contained in the electronic data.

6. The information processing apparatus according to claim 1, wherein the one or more processors and the one or more memories are further configured to, each time a predetermined time period has elapsed, determine a timing for calculating the code while targeting the partial data contained in the electronic data.

7. The information processing apparatus according to claim 1, wherein the one or more processors and the one or more memories are further configured perform the digital signature processing on a second code that is generated by targeting data containing the code, the second code being to be used in verification of authenticity of the partial data.

8. The information processing apparatus according to claim 1, wherein the one or more processors and the one or more memories are further configured to perform calculation of a code other than the code determined to be pre-calculable at a timing before the start of the digital signature processing, at a timing after the start of the digital signature processing.

9. The information processing apparatus according to claim 8, wherein the one or more processors and the one or more memories are further configured to divide, in a case where an operation mode of the information processing apparatus has been changed, the partial data into first partial data and second partial data, the first partial data containing information, among a series of information contained in the partial data, indicating that the code is pre-calculable, the second partial data containing pieces of information other than the information.

10. The information processing apparatus according to claim 9, wherein the one or more processors and the one or more memories are further configured to merge, among the series of information contained in each of a plurality of pieces of the partial data, the pieces of information other than the information indicating that the code is pre-calculable into one piece of partial data, and calculate the code while targeting the partial data.

11. The information processing apparatus according to claim 1, wherein the partial data is at least either one of image data, meta data of the image data, and data related to image capturing conditions.

12. The information processing apparatus according to claim 11, wherein the information processing apparatus is an imaging apparatus for generating the image data according to an imaging result.

13. The information processing apparatus according to claim 1, wherein a hash value is applied as the code.

14. A method for controlling an information processing apparatus comprising:
determining, for partial data contained in electronic data to be a target of digital signature processing, a timing for calculating a code to be used in verification of authenticity of the partial data; and
performing, as a first calculation, pre-calculation of the code determined to be pre-calculable at a timing before a start of the digital signature processing, at the timing.

15. A non-transitory storage medium storing a program causing an information processing apparatus to execute a method for controlling the information processing apparatus, the method for controlling comprising:
determining, for partial data contained in electronic data to be a target of digital signature processing, a timing for calculating a code to be used in verification of authenticity of the partial data; and
performing, as a first calculation, pre-calculation of the code determined to be pre-calculable at a timing before a start of the digital signature processing, at the timing.
